(19) United States
(12) Patent Application Publication
(10) Pub. No.: US 2014/0372672 A1
(43) Pub. Date: Dec. 18, 2014

(54) SYSTEM AND METHOD FOR PROVIDING IMPROVED SYSTEM PERFORMANCE BY MOVING PINNED DATA TO OPEN NAND FLASH INTERFACE WORKING GROUP MODULES WHILE THE SYSTEM IS IN A RUNNING STATE

(71) Applicant: LSI Corporation, San Jose, CA (US)

(72) Inventors: Harshavardhan S. Lokare, Bangalore (IN); Naveen A. Yathagiri, Bangalore (IN); Abhilash N. Parthasarathy, Bangalore (IN); Sampath K. Boraiah, Ramanagara (IN)

(73) Assignee: LSI Corporation, San Jose, CA (US)

(21) Appl. No.: 14/277,975

(22) Filed: May 15, 2014

(30) Foreign Application Priority Data
Jun. 17, 2013 (IN) 722/KOL/2013

(51) Int. Cl. G06F 3/06

(52) U.S. Cl. CPC G06F 3/0647; G06F 3/0604; G06F 3/0688; G06F 3/0664
USPC 711/103

(57) ABSTRACT

Aspects of the disclosure pertain to a system and method for providing improved system performance by moving pinned data to ONFI module(s) while the system is in a running state. Further, when a virtual array of the system is offline, the system allows for scheduling and performance of background operations on virtual arrays which are still online. These characteristics promote the ability of the online virtual arrays to operate efficiently in the presence of the pinned data.

### FIELD OF THE INVENTION

The present disclosure relates to the field of electronic data handling and particularly to a system and method for providing improved system performance by moving pinned data to Open NAND Flash Interface Working Group (ONFI) modules while system is in a running state.

### BACKGROUND

Host controllers (e.g., disk array controllers) manage physical disk drives and present them to a host system (e.g., a computer) as logical units. Host controllers often include a cache for speeding up access to data stored in the physical disk drives. However, if a drive group of the physical disk drives enters an offline state from an optimal state, and data corresponding to the offline drive group is pinned in the host controller cache, performance of the other drive groups (e.g., optimal drive groups, online drive groups) of the physical disk drives is adversely affected.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter in any manner

Aspects of the disclosure pertain to a system and method for providing improved system performance by moving pinned data to ONFI module(s) while the system is in a running state.

### DESCRIPTION OF THE FIGURES

The detailed description is described with reference to the accompanying figures:

FIG. 1 is an example conceptual block diagram schematic of a system in accordance with an exemplary embodiment of the present disclosure; and

FIG. 2 is a flow chart illustrating a method of operation of a controller of the system shown in FIG. 1, in accordance with an exemplary embodiment of the present disclosure.

### WRITTEN DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope. Among other things, the features of the disclosure can be facilitated by methods, devices, and/or embodied in articles of commerce. The following detailed description is, therefore, not to be taken in a limiting sense.

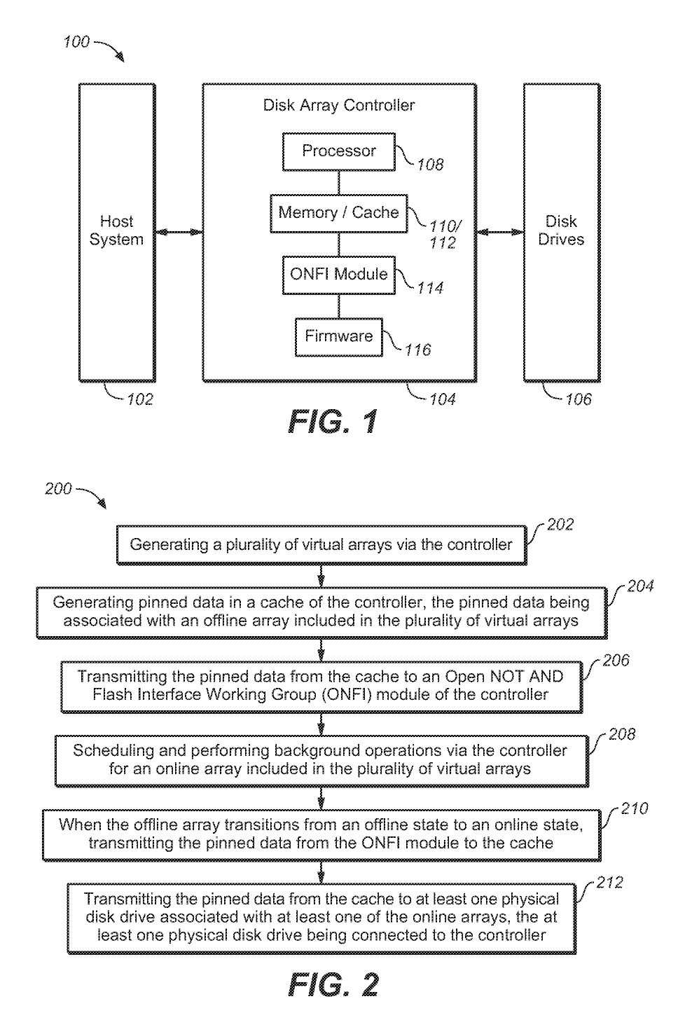

Referring to FIG. 1 (FIG. 1), a system 100 in accordance with an exemplary embodiment of the present disclosure is shown. In embodiments, the system 100 includes a host system (e.g., a computer) 102. In embodiments, the host system 102 is a networked computer that provides services to other systems or users. For example, the services may include, but are not limited to, printer, web or database access.

In embodiments, the system 100 includes a host controller 104. In embodiments, the host controller 104 is a direct attached storage (DAS)-based controller. In embodiments, the host controller 104 is a Redundant Array of Independent Disks (RAID) controller (e.g., a RAID adapter), such as a MegaRAID® controller (e.g., a MegaRAID adapter). In embodiments, the host controller 104 is connected to (e.g., communicatively coupled with) the host system 102.

In embodiments, the system 100 includes a plurality of data storage devices (e.g., devices for recording and storing information/data), such as physical disk drives (e.g., hard disk drives) 106. In embodiments, the host controller 104 is connected to (e.g., communicatively coupled with) the plurality of physical disk drives 106. In embodiments, the system 100 implements RAID and the plurality of disk drives 106 is a RAID array. In embodiments, RAID is a storage technology that combines multiple disk drive components (e.g., combines the disk drives 106) into a logical unit. In embodiments, data is distributed across the drives 106 in one of several ways, depending on the level of redundancy and performance required. In embodiments, RAID is computer data storage scheme that divides and replicates data among multiple physical drives (e.g., the disk drives 106). In embodiments, RAID is an example of storage virtualization and the array (e.g., the disk drives 106) can be accessed by an operating system as a single drive.

In embodiments, the host controller (e.g., disk array controller) 104 is configured for managing the physical disk drives 106. In embodiments, the host controller 104 is configured for presenting the physical disk drives 106 to the host system 102 as logical units. In embodiments, the host controller 104 includes a processor 108. In embodiments, the host controller 104 further includes a memory 110. In embodiments, the processor 108 of the host controller 104 is connected to (e.g., communicatively coupled with) the memory 110 of the host controller 104. In embodiments, the processor 108 is hardware which carries out the instructions of computer program(s) by performing basic arithmetical, logical and input/output operations. In embodiments, the processor 108 is a multi-purpose, programmable device that accepts digital data as an input, processes the digital data according to instructions stored in the memory 110, and provides results as an output.

In embodiments, the memory 110 of the host controller is or includes a cache (e.g., disk cache) 112. In embodiments, the system 100 implements caching, which is a technique that uses a smaller, faster storage device (e.g., cache 112) to speed up access to data stored in a larger, slower storage device (e.g., disk drive(s) 106). In embodiments, cache 112 is a component that transparently stores data so that future requests for that data are served faster. In embodiments, the data stored in the cache 108 includes previously computed values and/or duplicates of original values that are stored elsewhere. In embodiments, if requested data is in the cache 112 (e.g., cache hit), the request is served by simply reading the cache 112 (which is faster). In embodiments, if requested data is not in the cache 112 (e.g., cache miss), the data is recomputed or fetched from its original storage location, which is comparatively slower. In embodiments, the more requests that can be served from cache 112, the faster overall system performance becomes. In embodiments, hardware implements cache 112 as a block of memory 110 for temporary storage of data likely to be used again. In embodiments, the cache 112 is dynamic random-access memory (DRAM). For example, the DRAM 112 has a digital information storage capacity ranging from one Gigabyte (1 GB) to four Gigabytes (4 GB).

In embodiments, the host controller 104 is configured for being placed inside the host system (e.g., computer) 102. In embodiments, the host controller 104 is configured as a Peripheral Component Interconnect (PCI) expansion card, which is configured for being connected to a motherboard of the host system 102 by being received via a card expansion slot of the host system 102. In other embodiments, the host controller 104 is configured for being built directly onto the motherboard of the host system 102. In embodiments, the host controller (e.g., RAID adapter) 104 is configured for providing host bus adapter functionality. For example, the host controller 104 is configured for connecting the host system 102 to other network and storage devices.

In embodiments, the system 100 includes an Open NAND Flash Interface Working Group (ONFI) module 114. In embodiments, NAND stands for “NOT AND” or “Negated AND”. In embodiments, the ONFI module 114 is connected to (e.g., is included within) the host controller 104. In embodiments, the ONFI module 114 is configured for storing data (e.g., electronic data). In embodiments, the ONFI module 114 has a digital information storage capacity that is generally much larger (e.g., at least four times larger) than the digital information storage capacity of the cache (e.g., DRAM) 112 of the host controller 104. For example, if the digital information storage capacity of the cache (e.g., DRAM) 112 is 4 GB, the digital information storage capacity of the ONFI module 114 may be 16 GB.

In embodiments, the host controller 104 is user-configurable (e.g., user-programmable) to allow for virtual drive creation by a user of the host controller 104. In embodiments, the user configures (e.g., creates) multiple arrays (e.g., drive groups) on (e.g., via) the host controller (e.g., RAID adapter) 104, the multiple arrays being configured based upon the physical disk drives 106. In embodiments, each of the configured arrays/drive groups (e.g., virtual drive(s), virtual drive group(s)) are associated with (e.g., correspond to) one or more of the physical disk drives 106. For example, a user may configure ten arrays (e.g., ten drive groups) on the host controller 104, the ten arrays being configured for operating in write-back mode (e.g., the ten arrays being write-back (WB) arrays). In write-back mode, writes are initially done only to the cache 112, the write to the backing store (e.g., the physical disk drives 106) being postponed until cache blocks containing the data are about to be modified/replaced by new content. In further embodiments, a user configures the arrays/drive groups to operate in always read ahead mode. In always read ahead mode, the RAID controller 104 reads a whole stripe containing a requested data block and keeps it in the cache 112.

In embodiments, the host controller 104 is user-configurable (e.g., user-programmable) for allowing a user to schedule background operations, such as background initialization (BGI) and patrol read (PR) to be run. For example, these background operations (e.g., BGI and PR) may be programmed to run on a daily basis. Further, these background operations (e.g., BGI and PR) may be programmed to run for sufficient duration to promote data consistency. In embodiments, background initialization (BGI) allows a user to utilize an array being initialized, while the initialization is taking place. In embodiments, patrol read (PR), also known as data scrubbing, is the periodic reading and checking by the RAID controller 104 of all the blocks (e.g., data blocks) in a RAID array, including those not otherwise accessed. PR allows for bad blocks to be detected before they are used. Further, PR is a check for bad blocks on each storage device 106 in the array. Still further, PR uses the redundancy of the RAID array to recover bad blocks on a single drive 106 and reassign the recovered data to spare blocks elsewhere on the drive 106.

In embodiments, when running inputs/outputs (I/Os) (e.g., writes, reads) on the write back arrays, firmware 116 of the host controller 104 is configured for returning I/O acknowledgements to the host system 102 when data is written to the cache 112, which leads to generating dirty cache lines, the dirty cache lines including dirty data. In embodiments, cache lines are blocks of fixed size via which data is transferred between the physical disk drives 106 and the cache 112. Soon after, the dirty data is committed to particular disks (e.g., physical disk drives 106) associated with particular write back arrays (e.g., configured drive groups). During this process of committing, if some of the WB arrays (e.g., optimal arrays) are moved from an optimal state (e.g., online state) to an offline state, the firmware 116 allows the dirty cache lines (e.g., the dirty data of the dirty cache lines) corresponding to the offline arrays to be pinned (e.g., preserved) in the cache. In embodiments, if physical disk drive(s) 106 (e.g., two or more physical disk drives) corresponding to (e.g., associated with) an optimal array move from an optimal state to an offline state (e.g., go from optimal/online to offline), data associated with the offline array/offline drive group gets pinned in the cache 112 (e.g., pinned data is generated on the controller/adapter 104) and the virtual array associated with the physical disk drive(s) that have gone offline is an offline array. In embodiments, certain objects (e.g., data) are kept pinned in the cache for a specified time. For example, the pinning of said data is usually done to ensure that the most popular objects (e.g., data) are in the cache 112 when needed and that important objects are not deleted from the cache 112.

In embodiments, when there are cache lines (e.g., data) pinned in the cache 112 for (e.g., associated with) offline drive groups, and when the system 100 is running (e.g., is in a running state), the host controller 104 is configured for offloading (e.g., transmitting) the pinned data from the cache 112 to the ONFI module 114. This allows for the pinned cache lines to be freed up so that they can be used (e.g., re-used) for operations associated with optimal drive groups (e.g., used for operations involving drive groups which are in an optimal state rather than an offline state). In embodiments, the offloading of the pinned data from the cache 112 to the ONFI module 114 allows for performance of the configured arrays (e.g., the optimal drive groups) to be retained (e.g., to not suffer any performance decrease due to the pinned data associated with the offline drive groups). For example, the optimal drive groups retain a same input/output operations per second (IOPS) metric, even if data associated with offline drive groups becomes pinned in the cache 112. In embodiments, IOPS is a common performance measurement used to benchmark computer storage devices (e.g., data storage devices), such as hard disk drives (HDD), solid state drives (SSD) and storage area networks (SAN). In embodiments, the offloading of the pinned data from the cache 112 to the ONFI module 114 prevents the firmware 116 of the controller 104 from changing properties of the optimal drive groups. For example, the offloading of the pinned data associated with the offline drive groups prevents the firmware 116 from changing the mode of the optimal drive groups from write-back mode to write-through mode, or from always read ahead mode to no read ahead mode, thereby promoting efficient performance of the system 100.

In embodiments, the host controller 104 is configured for allowing background operations to be scheduled (e.g., via the controller 104) and for performing background operations on optimal drive groups when pinned data associated with offline drive groups is generated in the cache 112. In embodiments, the host controller 104 is configured for allowing creation of arrays (e.g., creation of virtual drive groups) on/via the controller 104 when pinned data associated with offline drive groups is generated in the cache 112. For example, the firmware 116 of the host controller 104 allows for the creation of the virtual drive groups when pinned data is present in the cache 112. In embodiments, the firmware 116 is connected to (e.g., communicatively coupled with) one or more of the processor 108, the cache 112, and/or the ONFI module 114.

In embodiments, when offline arrays become optimal (e.g., move from an offline state to an optimal (e.g., online) state, or to a degraded state), the data associated with those previously offline arrays which had been pinned in the cache 112 and then offloaded to the ONFI module 114 is restored to (e.g., transmitted back to) the cache (e.g., DRAM module) 112 by the ONFI module 114. In embodiments, the restored pinned data is de-staged to (e.g., transmitted to) one or more physical disk drives 106 associated with the optimal array(s) or degraded array(s) (e.g., associated with the previously offline and now optimal or degraded array(s).

Referring to FIG. 2 (FIG. 2), a flowchart illustrating a method of operation of the controller 104 in accordance with an exemplary embodiment of the present disclosure is shown. In embodiments, the method 200 includes a step of generating a plurality of virtual arrays via the controller (Step 202). In embodiments, the controller 104 is user-programmable and is configured for generating a plurality of virtual arrays based upon user inputs provided to the controller 104. For example, the plurality of virtual arrays are configured for operating in one or more modes, such as write-back (WB) mode, concurrent input/output (CIO) mode, and/or always read ahead (ARA) mode. Further, each of the virtual arrays corresponds to one or more physical disk drives 106 connected to the controller 104.

In embodiments, the method 200 includes a step of generating pinned data in a cache of the controller, the pinned data being associated with an offline array included in the plurality of virtual arrays (Step 204). For example, when an array included in the plurality of virtual arrays moves (e.g., changes) from an optimal (e.g., online) state to an offline state, the controller 104 is configured for pinning data in the cache 112 of the controller 104, the pinned data being associated with the offline array.

In embodiments, the method 200 includes a step of transmitting the pinned data from the cache to an Open NAND Flash Interface Working Group (ONFI) module of the controller (Step 206). For example, after the pinned data associated with the offline array is generated in the cache 112, while the system 100 (e.g., the controller 104 of the system 100) is in a running state, the pinned data is transmitted (e.g., offloaded) from the cache 112 to the ONFI module 114.

In embodiments, the method 200 includes a step of scheduling and performing background operations via the controller for an online array included in the plurality of virtual arrays (Step 208). For example, when the array included in the plurality of virtual arrays is offline, the controller 104 is configured for scheduling and performing background operations, such as background initialization (BGI) and/or patrol read (PR) for online array(s) (e.g., optimal arrays, arrays which are in an optimal state) included in the plurality of virtual arrays.

In embodiments, the method 200 includes a step of, when the offline array becomes an online array (e.g., moves from the offline state to an online state) or becomes a degraded state array (e.g., degraded array), transmitting the pinned data from the ONFI module to the cache (Step 210). For example, when the offline array goes back online (e.g., is in an optimal state, becomes an optimal array), or moves to a degraded state, the pinned data is transmitted from the ONFI module 114 to the cache 112.

In embodiments, the method 200 includes a step of transmitting the pinned data from the cache to at least one physical disk drive associated with at least one of the online (e.g., optimal) arrays (Step 212), the at least one physical disk drive being connected to the controller. For example, the controller 104 is configured for de-staging the pinned data from the cache 112 to one or more physical disk drives 106 associated with an online array (e.g., the array that moved from an offline state to an online (e.g., optimal) state.

It is to be noted that the foregoing described embodiments may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the embodiments described herein may be conveniently implemented in forms of a software package. Such a software package may be a computer program product which employs a non-transitory computer-readable storage medium including stored computer code which is used to program a computer to perform the disclosed functions and processes disclosed herein. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of operation of a disk array controller, the method comprising:
generating a plurality of virtual arrays via the controller;
generating pinned data in a cache of the controller, the pinned data being associated with an offline array included in the plurality of virtual arrays; and
transmitting the pinned data from the cache to an Open NOT AND Flash Interface Working Group (ONFI) module of the controller.

2. The method as claimed in claim 1, further comprising:
scheduling and performing background operations via the controller for an online array included in the plurality of virtual arrays.

3. The method as claimed in claim 2, further comprising:
when the offline array transitions from an offline state to an online state or to a degraded state, transmitting the pinned data from the ONFI module to the cache.

4. The method as claimed in claim 3, further comprising:
transmitting the pinned data from the cache to at least one physical disk drive associated with at least one of the online arrays, the at least one physical disk drive being connected to the controller.

5. The method as claimed in claim 1, wherein the disk array controller is a Redundant Array of Independent Disks (RAID) controller.

6. The method as claimed in claim 1, wherein each of the plurality of virtual arrays is a write-back array.

7. The method as claimed in claim 2, wherein the background operations include one of: background initialization operations and patrol read operations.

8. A non-transitory computer-readable medium having computer-executable instructions for performing a method of operation of a disk array controller, the method comprising:
generating a plurality of virtual arrays;
generating pinned data in a cache of the controller, the pinned data being associated with an offline array included in the plurality of virtual arrays; and
transmitting the pinned data from the cache to an Open NOT AND Flash Interface Working Group (ONFI) module of the controller.

9. The non-transitory computer-readable medium as claimed in claim 8, the method further comprising:
scheduling and performing background operations for an online array included in the plurality of virtual arrays.

10. The non-transitory computer-readable medium as claimed in claim 9, the method further comprising:
when the offline array transitions from an offline state to an online state or degraded state, transmitting the pinned data from the ONFI module to the cache.

11. The non-transitory computer-readable medium as claimed in claim 10, further comprising:
transmitting the pinned data from the cache to at least one physical disk drive associated with at least one of the online arrays, the at least one physical disk drive being connected to the controller.

12. The non-transitory computer-readable medium as claimed in claim 8, wherein the disk array controller is a Redundant Array of Independent Disks (RAID) controller.

13. The non-transitory computer-readable medium as claimed in claim 8, wherein each of the plurality of virtual arrays is one of: a write-back array, a concurrent input/output mode array, and an always read ahead array.

14. The non-transitory computer-readable medium as claimed in claim 9, wherein the background operations include one of: background initialization operations and patrol read operations.

15. A disk array controller, comprising:
a processor;
a cache, the cache being connected to the processor;
an Open NOT AND Flash Interface Working Group (ONFI) module, the ONFI module being connected to the cache,
wherein the disk array controller is configured for creating a virtual array corresponding to one or more physical data storage devices connected to the disk array controller, the disk array controller being further configured for, when a state of the virtual array changes from online to offline, generating pinned data in the cache and transmitting the pinned data from the cache to the ONFI module.

16. The disk array controller as claimed in claim 15, wherein the transmitting of the pinned data to the ONFI module occurs when the processor is in a running state.

17. The disk array controller as claimed in claim 16, the disk array controller being further configured for, when the state of the virtual array changes from offline to online or degraded: transmitting the pinned data from the ONFI module to the cache, and then transmitting the pinned data from the cache to the one or more physical data storage devices corresponding to the virtual array.

18. The disk array controller as claimed in claim 15, wherein the disk array controller is a Redundant Array of Independent Disks (RAID) controller.

19. The disk array controller as claimed in claim 15, wherein the cache is dynamic random-access memory (DRAM).

20. The disk array controller as claimed in claim 15, wherein the disk array controller is a Peripheral Component Interconnect (PCI) expansion card configured for being connected to a motherboard of a host system.
